(19) United States
(12) Patent Application Publication
(10) Pub. No.: US 2009/0057604 A1
(43) Pub. Date: Mar. 5, 2009

(54) Man-made material presenting magnetic response at different frequencies

(75) Inventors: Ta-Jen Yen, Hsinchu County (TW); Chia-Yun Chen, Kaohsiung City (TW)

Correspondence Address: Joe McKinney Muncy, PO Box 1364, Fairfax, VA, 22038-1364, US

(73) Assignee: National Tsing Hua University

(21) Appl. No.: 11/892,759

(22) Filed: Aug. 27, 2007

(51) Int. Cl. H01F 1/04; H01F 1/00; H01F 1/14

(52) U.S. Cl. 252/62.55; 252/62.51 R

(57) ABSTRACT

A man-made magnetic material presenting magnetic response at different frequencies is made from non-magnetic conductive metal and formed in a four-way symmetrical structure consisting of four L-shaped units. A plurality of the four-way symmetrical structures is arranged to form a periodic array. The four-way symmetrical structure is formed at a size much smaller than the wavelength of incident light. Hence it is treated as an effective uniform medium in terms of the incident light. Such a novel planar structure can generate magnetic response in a wide range of bandwidth. The frequency band capable of generating the magnetic response also can be regulated and altered through control of the structural size.

### FIELD OF THE INVENTION

The present invention relates to a man-made magnetic material presenting magnetic response at different frequencies based on which a magnetic responding symmetrical structure is made and the frequency band for generating the response can be regulated and altered through control of the structural size.

### BACKGROUND OF THE INVENTION

Material development and exploring of their characteristics are a constant quest for mankind. Starting from earth-ware, bone-ware and pottery in the ancient time to applications of metals such as bronze, copper, iron and the like, human beings have made constant progress in utilization of materials. These progresses show that human beings try to use the best and most desirable material available at a given time after having explored and studied the characteristics of materials. A milestone of this research occurred after the Maxwell's Law was published. Electromagnetic theory advances rapidly after that. Research of electromagnetic characteristics for all types of material that have been previously studied have been resumed again.

After having gained some degree of understanding of the natural materials and established characteristic definitions and inspection methods for materials, in order to facilitate experiments or find materials equipped with more desirable characteristics than the original materials, scientists have tried to study and fabricate man-made material. By the end of nineteen century, the concept of man-made special shape and microstructure fabrication was well-accepted. In twenty century material science has great progress. The importance of man-made material also increases. With the development of computer, these days people can quickly predict various characteristics of material, calculate optical and electromagnetic phenomena. Advances in precision industry and micro-electromechanical technology make accurate and miniature fabrication possible. This results in more complexity in man-made material. For instance, Fused Fiber Couplers (FFCs), Fiber Bragg Gratings (FBGs), multi-layer fibers, multi-layer planar waveguide and the like are man-made products accomplished through precision fabrication.

Meta-material is a composite material formed by regularly arranging the composing materials. It has characteristics that are more desirable or non-exist in the natural material. The individual composing materials do not have these characteristics. These characteristics are available because of interaction or accumulative effect of other portions.

The magnetic response of most natural materials vanishes when the electromagnetic wave frequency is at about 100 GHz. A few material such as ferromagnetic material or antiferromagnetism material can generate magnetic response, but is tenuous. As a result, research related to magnetic reaction has been limited to low frequency band for a long period of time without significant breakthrough. Only recently meta-material becomes a hot topic because of its having electromagnetic characteristics that can be maneuvered. By applying the resonance concept on the non-magnetic conductor (such as metal), a strong magnetic response as much as many times than the natural material can be generated on the non-magnetic conductor (such as metal) at high frequency band (above GHz or THz).

Based on the definition of the magnetic dipole moment (m), the following equation can be derived:

$$m = \frac{1}{2} {\int }_{V} r \times j d V \qquad ( 1 )$$

where r is the radius of a coil and j is current intensity. Under the action of a time-varying magnetic field, when an induced local current flows around a closed coil, a magnetic dipole moment is generated. By bringing the resonance characteristics to the coil, the magnetic dipole moment can be increased through the meta-material, even negative magnetic permeability can be achieved. This is almost not possible for the natural material at the high frequency.

An article entitled “The Electrodynamics of Substances with Simultaneously Negative Values of ∈ and μ” published on Sov. Phys. Usp. By V. G. Veselago in 1968 first revealed that the dielectric constant∈ and magnetic permeabilityμ could be negative at the same time. Meanwhile the reflective index also is negative. At that time the material with a negative reflective index while the dielectric constant∈ and magnetic permeabilityμ are negative did not exist. In 1996 English scholar J. B. Pendry proposed a metallic linear structure which has a negative equivalent dielectric constant ∈ at a microwave frequency band, and established a model and theoretical analysis for such a structure. In 1999, Pendry further proposed a split ring resonance concept and got a negative magnetic permeability μ at the microwave frequency band, and also established a model and analysis for such a structure.

In 1999 J. B. Pendry proposed a number of man-made magnetic material structures which have a periodic layout consisting of split rings or tubular non-magnetic conductor resonant units like a LC resonator equipped with a capacitor and an inductor. Take split-ring resonators as an example for the following discussion. As previously discussed, the concept of the split-ring resonator to generate magnetic response is as follow: a time-varying magnetic field induces current on a planar circuit, and the circulating current generates magnetic response. The inductance of the split-ring resonator and the capacitance resulting from the split-ring form resonance to boost the magnetic response. The equivalent magnetic permeabilityμ can be obtained according to the following formula:

$$μ ( ω ) = 1 - \frac{F {ω}^{2}}{{ω}^{2} - {ω}_{0}^{2} + iωΓ} \qquad ( 2 )$$

where F is the geometric factor of the structure, ω₀ is the resonance frequency, and Γ is the resistance loss.

In 2001, R. A. Shelby, D. R. Smith and S. Schultz of University of California at San Diego published on Science an article entitled “Experimental Verification of a Negative Index of Refraction”. Based on Pendry's theory they made a successful experiment of a material with a negative reflective index through a split ring and metallic linear structure that has a reflective index n=−2.7 at the frequency of 10.5 GHz.

However, the theory of J. B. Pendry is based on resonance, and is sensitive to the frequency. The material of negative reflective index made by the team of UCSD has a narrow response bandwidth. The central frequency of the material of negative reflective index is about 10.5 GHz. The frequency is about 10-11 GHz when the reflective index is negative. Namely the bandwidth is merely (11−10)×100%/10.5=9.52%. Hence to discover a magnetic material capable of responding a wider bandwidth is the next goal pursuing by the scientists.

### SUMMARY OF THE INVENTION

Therefore the primary object of the present invention is to provide a man-made magnetic material capable of presenting magnetic response at different frequencies. The invention is made from non-magnetic conductive metal and has a four-way symmetrical structure consisting of four L-shaped units. And a plurality of the four-way symmetrical structures are arranged to form a periodic array. Such a periodic array has a unit cell size much smaller than the wavelength of electromagnetic waves. Hence in terms of the electromagnetic waves it can be treated as an effective uniform medium. Through such a novel planar structure the invention can cover a wide range of bandwidth and present magnetic response, even up to THz frequency band or above. The frequency band capable of generating the magnetic response can also be regulated and altered through control of structural size.

Another object of the invention is to reduce the directional restriction for presenting the magnetic response through the four-way symmetrical structure of the invention.

Yet another object of the invention is to provide a resonant structure to generate resonance with incident electromagnetic waves to form a strong electromagnetic energy localization and result in a gain effect for the electric field to be used in applications of optical elements and bio-sensing.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the four-way symmetrical structure of the invention.

FIG. 2 is a schematic view of the periodic array of the four-way symmetrical structure of the invention.

FIG. 3 is a schematic view of the related parameters of the four-way symmetrical structure of the invention.

FIG. 4 is a schematic view of the present invention with the direction of the incident electromagnetic wave traveling from the left side to the right side.

FIG. 5 is a schematic view of the present invention with the direction of the incident electromagnetic wave traveling from the upper side to the lower side.

FIG. 6 is a chart showing the permeating condition of the incident electromagnetic wave traveling from the left side to the right side based on structural parameters 1.

FIG. 7 is a chart showing the permeating condition of the incident electromagnetic wave traveling from the upper side to the lower side based on structural parameters 1.

FIG. 8 is a chart showing the permeating condition of the incident electromagnetic wave traveling from the left side to the right side based on structural parameters 2.

FIG. 9 is a chart showing the permeating condition of the incident electromagnetic wave traveling from the upper side to the lower side based on structural parameters 2.

FIG. 10 is a chart showing the permeating condition of the incident electromagnetic wave traveling from the left side to the right side based on structural parameters 3.

FIG. 11 is a chart showing the permeating condition of the incident electromagnetic wave traveling from the upper side to the lower side based on structural parameters 3.

### DETAILED DESCRIPTION OF THE PREFERRED EMBODIMENT

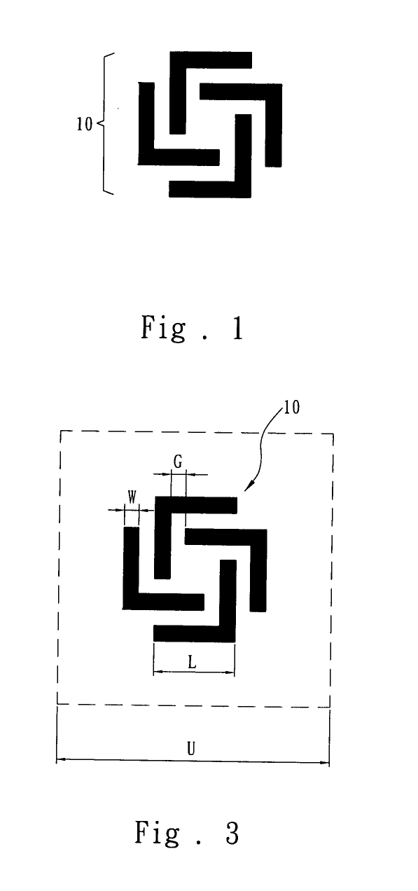

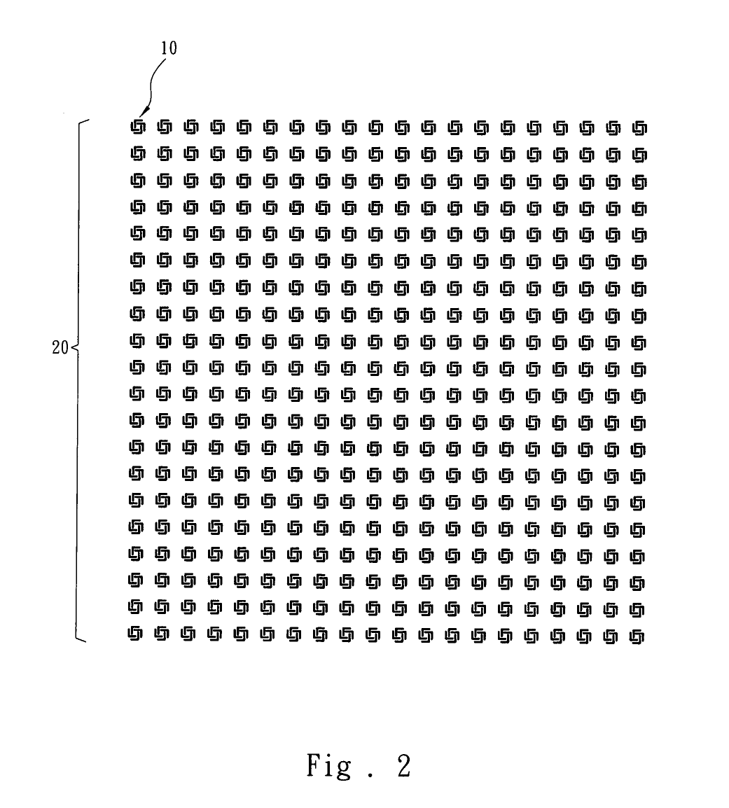

Please refer to FIG. 1 for the four-way symmetrical structure of the invention. The invention is made from non-magnetic conductive metal and has a unit cell consisting of four L-shaped units to form a four-way symmetrical structure 10. Each L-shaped unit has one end adjacent to an inward turning angle of another L-shaped unit. Thus the four-way symmetrical structure 10 forms an inward turning. A plurality of the unit cells of the four-way symmetrical structure 10 are arranged in a periodic array 20 as shown in FIG. 2. By means of such a structure the man-made magnetic material can present magnetic response at different frequencies.

The unit cell size where each of the four-way symmetrical structure 10 is located in the periodic array 20 is much smaller than the wavelength of electromagnetic waves, hence in terms of the electromagnetic waves it can be treated as an effective uniform medium. Through such a novel planar structure the material of the invention can cover a wide range of bandwidth and present magnetic response, even up to THz frequency band or above. The frequency band capable of generating the magnetic response can also be regulated and altered through control of structural size. Such electromagnetic characteristics can be maneuvered and used in applications related to high frequency magnetism.

Moreover, as the four-way symmetrical structure 10 of the invention is an inward turning structure consisting of four L-shaped units in a four-way turning fashion, the directional restriction for presenting the magnetic response of the man-made material decreases.

Refer to FIG. 3 for the schematic view of the related parameters of the four-way symmetrical structure of the invention. To further explain the effect of the invention, the design and size of the four-way symmetrical structure 10 can be regulated and altered as desired, such as the dimension U and L of the unit cell, line width W and length L of the L-shaped unit, and the interval G of two L-shaped units. By providing such a capability the invention can generate desired magnetic response, and also increase the intensity of the magnetic response, and even get a negative magnetic permeability without directional restriction.

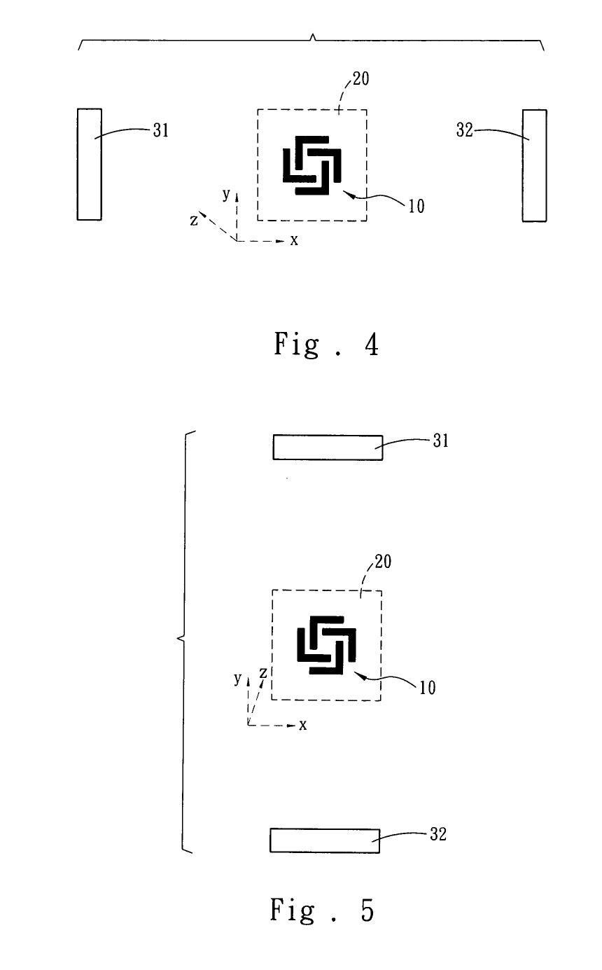

Refer to FIGS. 4 and 5 for the schematic views of the incident electromagnetic wave traveling in varying directions. Through a CST simulation software (3D electromagnetic field simulation software) impact of magnetic response generated by the four-way symmetrical structure 10 caused by different sizes can be analyzed. On the measurement equipment the four-way symmetrical structure 10 is disposed between a microwave emission source 31 and a receiving end 32 on a straight line and spaced from each of the two at a distance of 2 m. The man-made magnetic material of the invention is placed on a glass substrate which has a flat surface to hold the four-way symmetrical structure 10. The array 20 consisting of a plurality of the four-way symmetrical structure 10 is disposed flatly between the microwave emission source 31 and the receiving end 32. FIG. 4 shows that the incident direction of the electromagnetic wave is from the left side to the right side vertical to planar surface of the array 20. FIG. 5 shows that the incident direction of the electromagnetic wave is from the upper side to the lower side horizontal to the planar surface of the array 20.

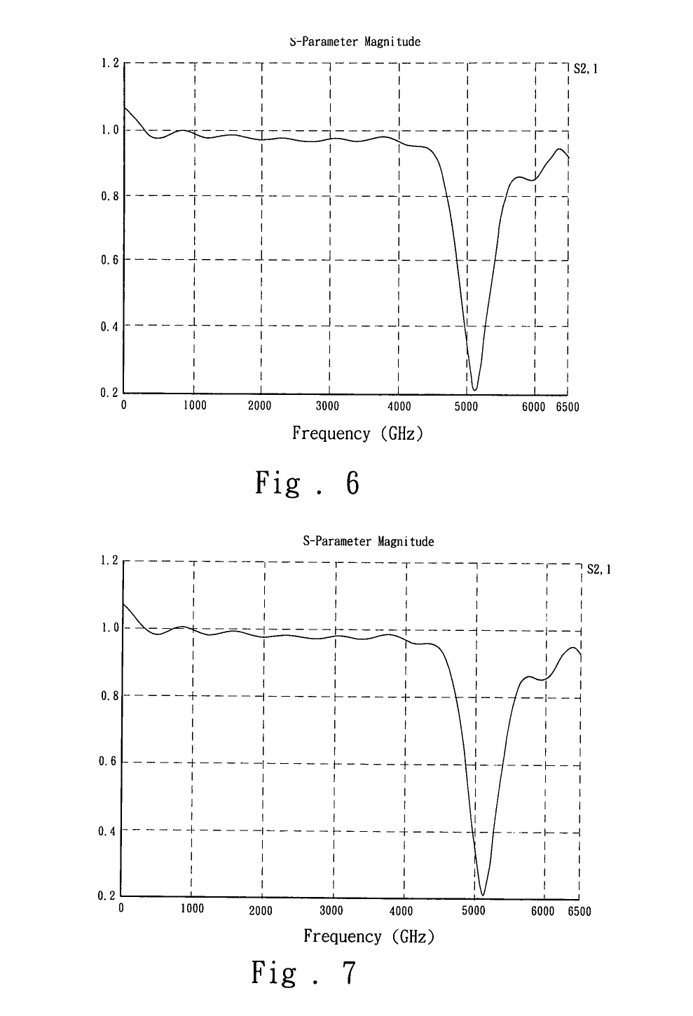

On structural parameters 1: unit cell size: U=2.7 μm, line width W=0.3 μm, length L=1.2 μm and interval G=0.3 μm. The result of measurement of the S-parameter magnitude through the CST simulation software is shown in FIG. 6, which indicates the permeating condition of the incident magnetic wave traveling from the left side to the right side under the structural parameters 1. FIG. 7 shows the permeating condition of the incident magnetic wave traveling from the upper side to the lower side under the structural parameters 1. The outcomes of the permeating condition of the electromagnetic wave in different incident directions are almost the same. When the frequency of the electromagnetic wave is about 52 THz, permeation does not occur.

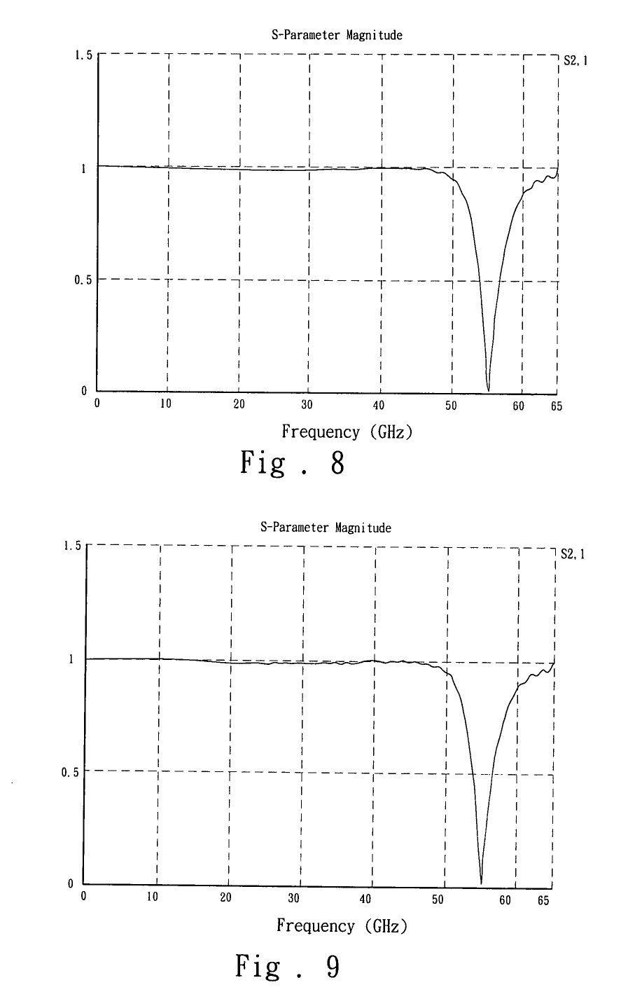

On structural parameters 2: unit cell size: U=2.7 mm, line width W=0.3 mm, length L=1.2 mm and interval G=0.3 mm. The result of measurement of the S-parameter magnitude through the CST simulation software is shown in FIG. 8, which indicates the permeating condition of the incident magnetic wave traveling from the left side to the right side under the structural parameters 2. FIG. 9 shows the permeating condition of the incident magnetic wave traveling from the upper side to the lower side under the structural parameters 2. The outcomes of the permeating condition of the electromagnetic wave in different incident directions are almost the same. When the frequency of the electromagnetic wave is about 56 GHz, permeation does not occur.

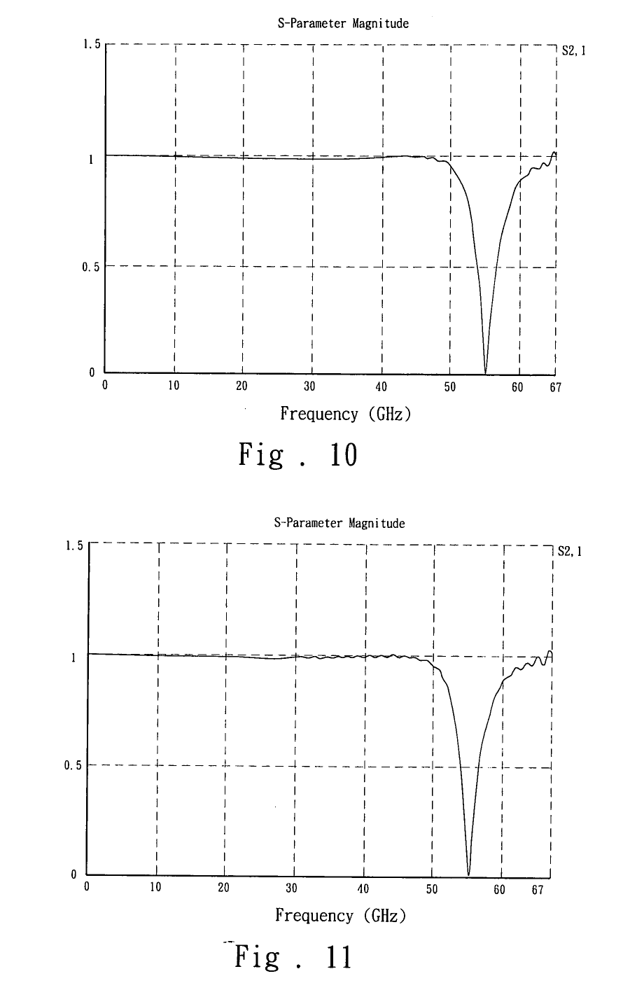

On structural parameters 3: unit cell size: U=2.7 cm, line width W=0.3 cm, length L=1.2 cm and interval G=0.3 cm. The result of measurement of the S-parameter magnitude through the CST simulation software is shown in FIG. 10, which indicates the permeating condition of the incident magnetic wave traveling from the left side to the right side under the structural parameters 3. FIG. 11 shows the permeating condition of the incident magnetic wave traveling from the upper side to the lower side under the structural parameters 3. The outcomes of the permeating condition of the electromagnetic wave in different incident directions are almost the same. When the frequency of the electromagnetic wave is about 55 MHz, permeation does not occur.

The experimental results based on the three sets of structural parameters previously discussed show that the planar structure of the periodic array 20 consisting of the four-way symmetrical structure 10 of the invention can generate magnetic response in a wide range of bandwidth. The magnetic response at different frequencies also can be obtained by regulating and controlling the structural size. Maximum magnetic response can be achieved by optimizing the parameters. It is known that the magnetic reaction of the general man-made magnetic material is affected by the direction of applied electromagnetic wave. However, due to the four-way symmetrical structure 10 of the invention provides a four-way turning symmetrical structure, the directional restriction of magnetic response can be reduced.

In addition, the man-made magnetic material made of the periodic array 20 consisting of the unit cells formed by the four-way symmetrical structure 10 has non-linear gain. This is due to the resonant structure of the four-way symmetrical structure 10. The non-linear gain is the result of resonance of the four-way symmetrical structure 10 and the incident electromagnetic wave. This can form a strong localization of electromagnetic energy and generate a great gain effect for electric field. This gain effect of the electric field can be used in optical elements and signal boosting of object detection such as SERS and applications in high frequency magnetism such as RFID and the like.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A man-made magnetic material presenting magnetic response at different frequencies, comprising:
a plurality of unit cells each consisting of four L-shaped units to form a four-way symmetrical structure, the unit cells being arranged to form a periodic array plane.

2. The man-made magnetic material of claim 1, wherein the four-way symmetrical structure is fabricated from a non-magnetic conductive metal.

3. The man-made magnetic material of claim 2, wherein the conductive metal is selected from the group consisting of gold, silver and copper.

4. The man-made magnetic material of claim 1, wherein each of the L-shaped units of the four-way symmetrical structure has one end adjacent to an inward turning angle of another L-shaped unit to form an inward turning symmetrical structure.
